(19) United States
(12) Patent Application Publication
(10) Pub. No.: US 2013/0081592 A1
(43) Pub. Date: Apr. 4, 2013

(54) COMBUSTION CONTROL FOR INTERNAL COMBUSTION ENGINES THROUGH FUEL TEMPERATURE AND PRESSURE

(71) Applicants: Chris De Boer, Newbury Park, CA (US); Kishwar Hossain, Glendale, CA (US); Shreeram Shetty, Camarillo, CA (US); Philip Zoldak, Chicago, IL (US)

(72) Inventors: Chris De Boer, Newbury Park, CA (US); Kishwar Hossain, Glendale, CA (US); Shreeram Shetty, Camarillo, CA (US); Philip Zoldak, Chicago, IL (US)

(21) Appl. No.: 13/249,789

(22) Filed: Sep. 30, 2011

(51) Int. Cl. F02M 53/06

(52) U.S. Cl. 123/299; 123/294

(57) ABSTRACT

Embodiments of the invention are directed toward a fuel injection system for a variable temperature and pressure direct injection engine, comprising: a high-pressure fuel pump capable of providing fuel at a pressure between 100 bar and 800 bar; a fuel heater for heating the fuel from 50° C. to 500° C.; and a common fuel rail operatively connected to at least one direct injector for injecting heated fuel into a cylinder of the engine.

### TECHNICAL FIELD

The present invention relates generally to internal combustion engines, and more particularly, some embodiments relate to combustion control and improved fuel efficiency for internal combustion engines through fuel temperature and pressure.

### DESCRIPTION OF THE RELATED ART

Development of stratified charge combustion systems is a complex technology involving multiple parameters. Such parameters may include engine geometry (B/S), compression ratio, intake air motion tuning (swirl and tumble), combustion chamber geometry, air guided fuel flow, wall guided fuel flow, fuel guided flow, injection timing, injection pressure, multiple shot injection, injector nozzle geometry, etc.

Despite the number of available variables, the eventual design of the combustion system frequently leads to compromises in performance. This may limit the potential fuel efficiency, exhaust emissions, combustion noise and other factors. The degree of stratification and the air/fuel ratio distribution are key parameters. In some instances, excessive lean or rich mixtures can lead to emissions and fuel efficiency compromises.

### BRIEF SUMMARY OF EMBODIMENTS OF THE INVENTION

According to various embodiments of the invention, a fuel injection system for an elevated temperature direct injection engine, comprises: a high-pressure fuel pump capable of providing fuel at a pressure between 100 bar and 800 bar; a fuel heater for heating the fuel from 50° C. to 500° C.; and a common fuel rail operatively connected to at least one direct injector for injecting heated fuel into a cylinder of the engine.

In the above-described system, the fuel heater may comprise a high-pressure exhaust gas recirculation system, wherein a ratio of exhaust gas to an amount of fuel is maintained in a range from 12.0:1 to 150.0:1 by volume. Alternatively, the fuel heater may derive its heating energy from an electric source. The high-pressure exhaust gas recirculation system may comprise a single-loop or double-loop exhaust gas recirculation system. The direct injector is capable of injecting fuel at an elevated temperature of 500° C. and an elevated pressure of 800 bar. In some embodiments, the direct injector enables single or multiple injection events directly into the cylinder from intake valve opening to exhaust valve opening, at various in-cylinder pressure and temperature levels.

In various embodiments, the direct injector includes a secondary heating element that provides fine tune control of temperature. The secondary heating element may or may not be used in conjunction with the fuel pre-heater. In operation, the injector individually regulates the temperature and fuel flow rate provided to the cylinder. In some cases, the heated fuel is in a supercritical phase during injection. According to some embodiments, a multiple elevated temperature injection strategy is employed to develop a stratified fuel charge, whereby a reduced amount of fuel is injected in at least two stages.

Another embodiment of the invention is directed toward a method for fuel injection for an elevated temperature direct injection engine, comprising: introducing air, including exhaust gas present at levels greater than 20% by total air mass, into a combustion chamber of the engine, the combustion chamber defined by a volume between a piston and a cylinder head; injecting the fuel at an elevated temperature; and igniting the fuel.

In the above-described method, a ratio of exhaust gas to an amount of fuel may be maintained in a range from 12.0:1 to 150.0:1 by volume, and fuel may injected at an elevated temperature of 500° C. and an elevated pressure of 800 bar. Injecting the fuel may entail multiple injection events for injecting fuel directly into the combustion chamber from intake valve opening to exhaust valve opening, at various in-cylinder pressure and temperature levels.

In some embodiments, the method may further comprise heating the fuel using a combination of the exhaust gas heating and a secondary heating element. In addition, injecting the fuel at an elevated temperature may comprise injecting the fuel in a supercritical phase. Furthermore, a multiple elevated temperature injection strategy is employed to develop a stratified fuel charge, whereby a reduced amount of fuel is injected in at least two stages.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating a light duty elevated temperature direct injection compression ignition (CI) engine including a single-loop high-pressure exhaust gas recirculation system (EGR), in accordance with an embodiment of the invention.

FIG. 2 includes four graphs illustrating testing results conducted on a single cylinder compression ignition engine.

FIG. 3 includes four graphs illustrating fuel temperature impact on engine ignition delay for 1000 rpm.

FIG. 4 includes graphs illustrating fuel temperature impact on engine ignition delay for 1500 rpm.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward combustion control and improved fuel efficiency for internal combustion engines through fuel temperature and pressure. Some embodiments provide a fuel injector capable of injecting the fuel at various temperatures and in different fluid phases, including liquid, gaseous and supercritical. In addition to providing combustion control and improved fuel efficiency, the fuel injector also provides the capabilities of a conventional injector.

The combustion system of an internal combustion engine requires that air and fuel be transported into the combustion chamber. Fuel transport is conventionally done either through injection into the intake port followed by aspiration of the fuel/air mixture into the combustion chamber or through the direct injection of the fuel into the combustion chamber.

Aspiration of the fuel naturally results in mixing of the fuel with air before and during the aspiration process as well as during the compression phase of the engine cycle prior to ignition and combustion. The resulting mixture is homogeneous and is common in spark ignition (SI) or compression ignition (i.e., HCCI—Homogeneous Charge Compression Ignition) combustion systems.

Direct injection of the fuel in to the combustion chamber naturally results in stratification of the fuel. In certain applications where a homogeneous charge is desirable, the injection process occurs during the aspiration process to provide time for the fuel to mix and vaporize to form an ignitable homogeneous mixture for SI or HCCI ignition and subsequent combustion. In other applications where a stratified charge is desirable, the injection process occurs during the compression phase prior to ignition.

The fuel injection pressure, temperature, geometry and timing along with the prevailing air motion characteristics determine: (i) the location of the fuel cloud(s), (ii) the degree to which it is vaporized, (iii) the degree to which it is atomized, and (iv) the degree to which it is mixed with the air in the cylinder in order to form an ignitable stratified mixture for SI and PCCI ignition (Premixed Charge Compression Ignition) and subsequent combustion. Under certain combustion conditions (determined by factors such as engine speed, load, efficiency, emission level and noise characteristics), the degree of control offered by injection pressure, temperature, geometry and timing results in compromised combustion performance resulting in reduced efficiency, high exhaust emissions, combustion noise and misfires.

Embodiments of the invention provide a fuel injector that (in addition to the capabilities of a conventional injector), is capable of injecting the fuel at various temperatures and in different fluid phases, including liquid, gaseous and supercritical. Additional combustion system control opportunities are described below.

In the case of liquid fuel injection, the following sequence occurs: (i) liquid fluid flow, (ii) break-up of the flow in to fluid ligaments, (iii) break-up of the fluid ligaments in to droplets, (iv) droplet evaporation, (v) formation of a vapor cloud (whose geometry and penetration characteristics are controlled by the injector nozzle geometry, fuel pressure, fluid properties, combustion chamber geometry and ambient conditions), and (vi) mixing of droplets, vapor with the cylinder charge.

For SI combustion using liquid fuel injection, ignition is phased appropriately when mixture formation is such that a mixture strength within the ignitable range is present at the location of the spark. For CI combustion, ignition takes place when the temperature, pressure history and mixture strength conditions lead to ignition and combustion. Combustion occurs in both pre-mixed air/fuel conditions as well as in diffusion combustion for rich zones and droplet burning.

In the case of gaseous fuel injection, the following sequence occurs: (i) gaseous fluid flow, (ii) formation of a vapor cloud (whose geometry and penetration characteristics are controlled by the injector nozzle geometry, fuel pressure, fluid properties, combustion chamber geometry and ambient conditions and (iii) mixing of gaseous fuel with the cylinder charge.

For SI combustion using gaseous fuel injection, ignition is phased appropriately when mixture formation is such that a mixture strength within the ignitable range is present at the location of the spark. For CI combustion, ignition takes place when the temperature, pressure history and mixture strength conditions lead to ignition and combustion. Combustion occurs in both pre-mixed air/fuel conditions as well as in diffusion combustion for rich zones and droplet burning.

In the case of supercritical fuel injection, the following sequence occurs: (i) supercritical fluid flow, (ii) formation of a vapor cloud (whose geometry and penetration characteristics are controlled by the injector nozzle geometry, fuel pressure, fluid properties, combustion chamber geometry and ambient conditions), and (iii) mixing of supercritical fuel with the cylinder charge.

For SI combustion using supercritical fuel injection, ignition is phased appropriately when mixture formation was such that a mixture strength within the ignitable range is present at the location of the spark. For CI combustion, ignition would take place when the temperature, pressure history and mixture strength conditions lead to ignition and combustion. Combustion occurs in both pre-mixed air/fuel conditions as well as in diffusion combustion for rich zones.

The fuel temperature in the injector combined with the pressure determines the state of the fuel (i.e., whether it is liquid, gaseous or supercritical). The temperature and state of the injected fuel in turn influences the mixture preparation mechanisms, as described above. The ability to control the fuel temperature in the injector (in combination with the engine parameters) influences the mixture preparation in the combustion chamber. Such engine parameters may include, but are not limited to: (i) engine geometry (B/S), (ii) compression ratio, (iii) intake air motion tuning (swirl and tumble), (iv) combustion chamber geometry, (v) air guided fuel flow, (vi) wall guided fuel flow, (vii) fuel guided flow, (viii) injection timing, (ix) injection pressure, and (x) injector nozzle geometry. Embodiments of the invention provide the ability to control the fuel temperature to enhance control of mixture formation for improved ignition and combustion. The ability to control fuel temperature thus provides a mechanism to create and fine tune mixture preparation leading to ignition and combustion.

Further embodiments of the invention provide a method, comprising the steps of: (i) providing air, including exhaust gas present at levels greater than 20% by total air mass; (ii) introducing the air (including the exhaust gas) into a combustion chamber having a volume including a piston and a cylinder head; (iii) injecting fuel at elevated temperatures (the elevated temperature fuel inherently has more energy than fuel at a non-elevated temperature); and (iv) igniting the fuel. The fuel may or may not be in a supercritical phase with fuel temperatures between about 50° C. and 500° C., and fuel pressures between approximately 100 bar and 800 bar. The total fuel mass may be injected directly into the combustion chamber with single or multiple amounts of fuel. In some embodiments, the ratio of air (including the exhaust gas) to the single or multiple amounts of fuel is maintained in a range from approximately 12.0:1 to 150.0:1 by volume.

Embodiments of the invention consider the dynamics of the injected fuel, characterized in terms of the Mach number. As used herein, the Mach number is the non-dimensional quantity defined as the ratio of velocity to the speed of sound. For the purposes of this disclosure, the Mach number of the fuel is limited to the range of 0.01 to 10.0. The optimal Mach number for a given load and injection condition is expected to be within this range.

Another embodiment of the invention involves an engine system for preparing a fuel air mixture reducing emissions and controlling rates of pressure rise. The system may include a combustion chamber having a volume including a piston and a cylinder head, an elevated temperature fuel injector configured to directly inject fuel into the combustion chamber at elevated temperature conditions, and an electronic control system in electrical communication with the fuel injector. The system may also include a high-pressure exhaust gas recirculation valve in electrical communication with the electronic control system and a low-pressure exhaust gas recirculation valve in electrical communication with the electronic control system. The electronic control system may be configured to introduce air (including exhaust gas present at levels greater than 20% by total air mass, into the combustion chamber), inject a single amount of fuel directly into the combustion chamber, or inject a multiple amount of fuel directly into the combustion chamber and ignite the single or multiple amounts of fuel, wherein the ratio of the air to the first and second amounts of fuel is between about 12.0:1 and 150.0:1 by volume.

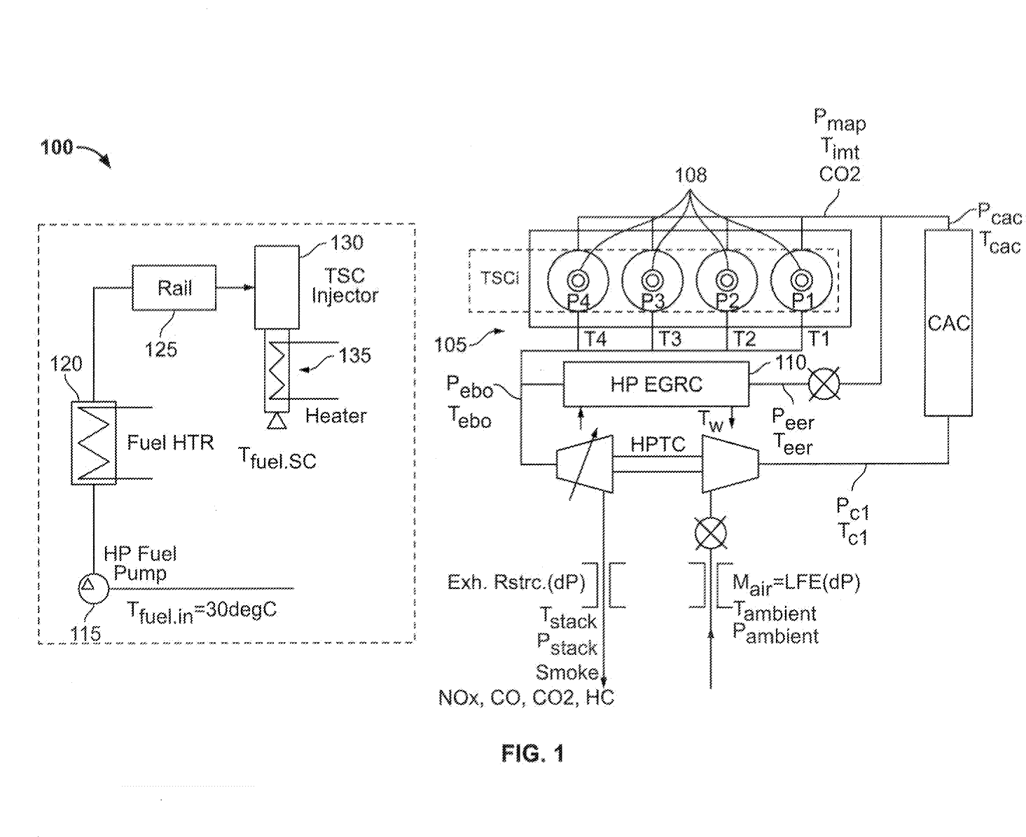

FIG. 1 is a diagram illustrating a light duty elevated temperature direct injection compression ignition (CI) engine system 100, in accordance with an embodiment of the invention. The system 100 comprises an elevated temperature direct injection CI engine 105 and a single-loop high-pressure exhaust gas recirculation system (EGR) 110. The engine 105 may run on various fuels such as gasoline, diesel fuel, high cetane fuel, high octane fuel, heptane, ethanol, plant oil, biodiesel, alcohols, plant extracts, and/or combinations thereof. In further embodiments, the system 100 may be modified such that engine 105 comprises a spark ignition (SI) engine that may or may not include alternative positive ignition methods such as plasma ignition.

In the illustrated embodiment, the elevated temperature direct injection CI engine 105 comprises a four-stroke engine. However, it will be appreciated by those of skill in the art that the elevated direct injection CI engine may be two strokes or higher (including two strokes to twelve strokes, and all required values and increments) without departing from the scope of the invention. In some embodiments, the elevated direct injection engine 105 comprises an SI combustion engine. In further embodiments, the engine may comprise an internal combustion engine with a dual-loop EGR system. In the illustrated embodiment, the engine 105 includes four cylinders 108; however, the engine may include any number of cylinders in a given engine application.

With further reference to FIG. 1, the elevated temperature fuel injection system 100 further comprises a high-pressure fuel pump 115 capable of providing fuel pressures between approximately 100 bar and 800 bar. The system 100 further comprises a fuel heater 120 capable of heating fuel from 50° C. to 500° C. The fuel heater 120 may derive its heating energy from an electric source or some other source, which may or may not comprise an exhaust gas source. The system 100 may also comprise a common fuel rail 125 operatively connected to a plurality of direct injectors 130 and capable of withstanding fuel at the aforementioned pressure and temperatures.

Each direct injector 130 is capable of injecting fuel at elevated temperatures (i.e., 50° C. to 500° C.) and elevated pressures (i.e., 150 bar to 800 bar). The injector 130 may be designed to enable single or multiple injection events directly into the cylinder from intake valve opening (IVO) to exhaust valve opening (EVO), at various in-cylinder pressure and temperature levels. The injector 130 may or may not include a secondary heating element 135 that provides fine tune control of temperature. In addition, the secondary heating element 135 may or may not be used in conjunction with the fuel pre-heater.

In one embodiment, each cylinder 108 may further have an associated elevated temperature fuel injector 130 such that each elevated temperature fuel injector 130 is operatively connected to common fuel rail 125. The common fuel rail 125 may be connected to a fuel supply and may supply fuel at elevated temperature substantially continuously to each injector fuel heater 120. The fuel heater 120 may comprise an electrically powered fuel heater and/or an exhaust gas or EGR gas waste heat recovery fuel heater. Each injector 130 may then individually regulate the final elevated temperature and fuel flow rate provided to each cylinder 108.

In some embodiments, the engine cylinder displacement is between about 0.1 liter and about 15 L. As used herein, engine displacement is understood as the volume swept by the piston as the piston top is moved from top dead center (TDC) to bottom dead center (BDC). Furthermore, the engine 105 may have a compression ratio of about 10:1 to about 30:1 by volume, where the compression ratio is understood as the change in volume of the combustion chamber when the piston is at the top dead center V_{TDC} and the bottom dead center V_{BDC}.

An elevated temperature fueled direct-injection charge may be developed by varying the injector fuel pressure and fuel temperature such that the fuel is injected at elevated temperatures (e.g., >50° C.), which may or may not be in the supercritical phase, prior to injection. The elevated temperature fuel (which inherently has more energy than fuel at a non-elevated temperature) is injected into the cylinder 108. Depending on the temperature and pressure of the cylinder charge and the injection timing, the fuel may remain in the elevated temperature phase during the injection in mixing into the cylinder 108 and/or may change phase to supercritical or liquid.

Depending on operating conditions, elevated temperature fueled direct-injection systems may provide a charge that varies in stratification (e.g., partially premixed and partially stratified elevated temperatures), wherein the air/fuel mixture may be layered. A rich elevated temperature spray jet may be directed outwards from the injector nozzle and towards the outer regions of the piston and cylinder. The fuel mixes rapidly with fresh air or a mixture of fresh air and EGR, creating an ignitable mixture that has an overall lean air fuel ratio that may also be close to overall stoichiometric air fuel ratio. The fuel air mixture may auto-ignite in regions where locally stoichiometric air fuel ratios are present and sufficient compression temperature is achieved. Combustion may initiate in these well-mixed regions and propagate to other regions of the cylinder 108 where local fuel air mixture is lean. Combustion may also initiate in regions surrounding the fuel spray jet, and may propagate towards other regions of well-mixed air and fuel, igniting some areas that are relatively lean and/or rich surrounding the fuel spray jet.

The elevated temperature injector 130 may be located in the centerline of the combustion chamber, offset to the centerline of the combustion chamber, or off to the side such that the injector 130 injects at a predetermined angle toward the center of the combustion chamber. For example, the system 100 may include a wall directed combustion system, where fuel may be injected into the combustion chamber from the side and deflected by a recess in the piston bowl towards the center.

In some embodiments of the invention, a multiple elevated temperature injection strategy may be employed to develop a premixed/stratified charge. As used herein, a multiple injection strategy is understood as an injection strategy wherein a smaller portion of fuel is injected in at least two stages. The early injection or injections may occur between about 170° to about 30° BTDC to create a premixed elevated temperature fuel charge. The main portion of elevated temperature fuel can be injected closer to TDC between approximately 30° and 0° BTDC. A late injection strategy may also be employed, wherein late injection occurs anywhere between about 10° to about −30° BTDC.

The early injection first portion of the fuel (e.g., a range of 1% to 60% of the total fuel mass injected for a given lean air fuel ratio charge), may be injected during the first stage by an injector 130. As noted above, the injector 130 may comprise a high-pressure injector, wherein the fuel is at a pressure of about 100 bar or greater, including all values and increments in the range of 100 bar to 800 bar. The first portion of fuel may mix with the incoming charge of air as the piston begins to extend towards TDC.

In some implementations of the invention, the cylinder charge may include not only ambient air drawn in through the compressor inlet piping, but also exhaust gas directed through the HP-EGR system or LP-EGR system. Exhaust gas may be present at levels greater than 20% by mass of the intake air. The exhaust gas may be low-pressure exhaust gas, high-pressure exhaust gas, or a mixture thereof, depending upon the load and temperature of the engine 105.

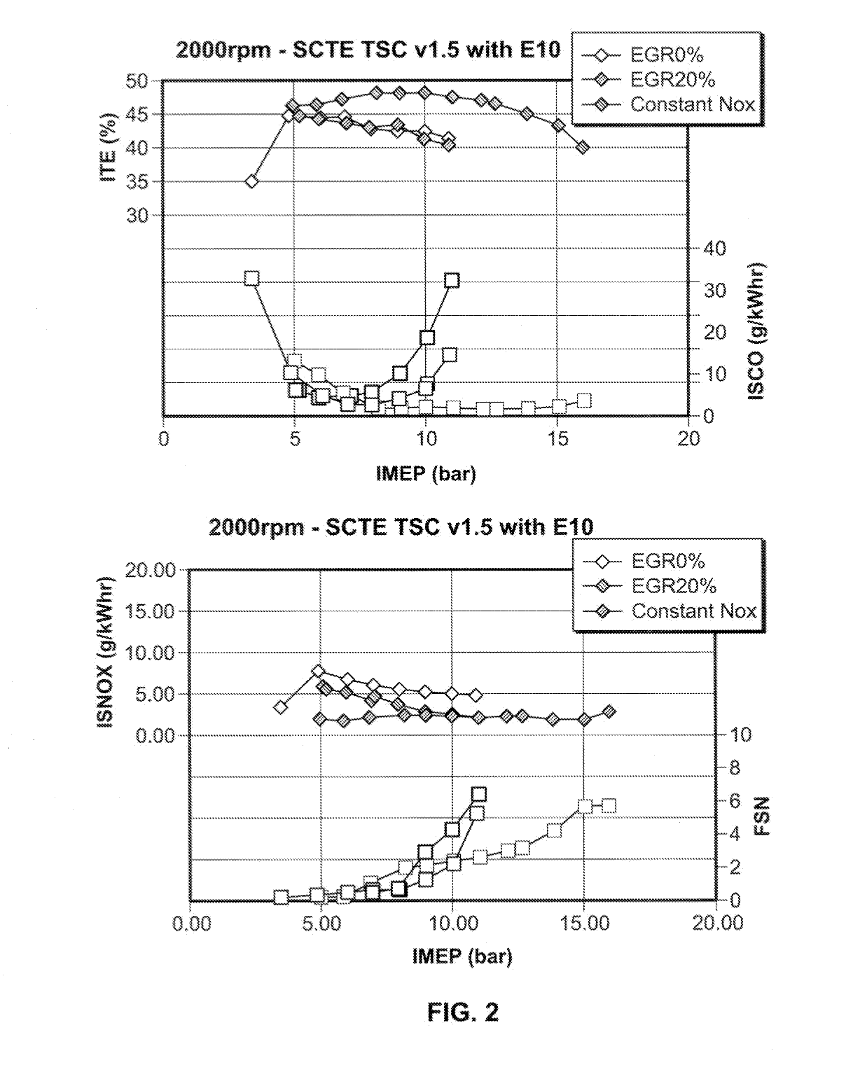

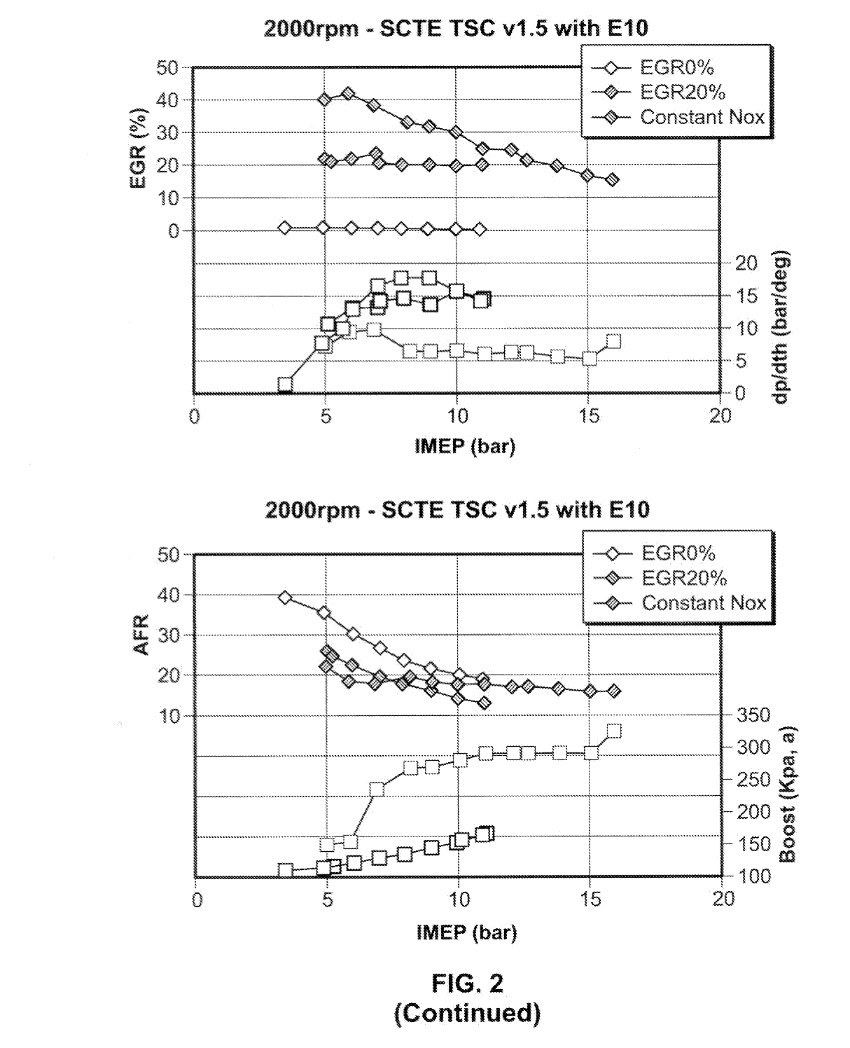

Initial engine testing conducted on single cylinder engines indicates that when using elevated temperatures (>300° C.), copious amounts of EGR (20-40%) are necessary to achieve NOx emission targets as well as manage rates of combustion pressure rise across the engine load range. This testing was completed at 2000 rpm on a 390 cc single cylinder engine using gasoline fuel and a compression ignition injection system. The results are presented in FIG. 2 including four graphs illustrating testing results.

The testing results show the amount of EGR needed to control NOx emissions to approximately 200 ppm and improvement in load range and thermal efficiency as a result. The baseline EGRO % load sweep was load limited due to excessively high smoke (FSN) and CO emissions. The need for copious EGR gas flow rates presents a unique opportunity for improved thermal efficiency and emission control, as well as waste heat recovery to a fuel heat exchanger.

Fuel Temperature Impact at Low Load

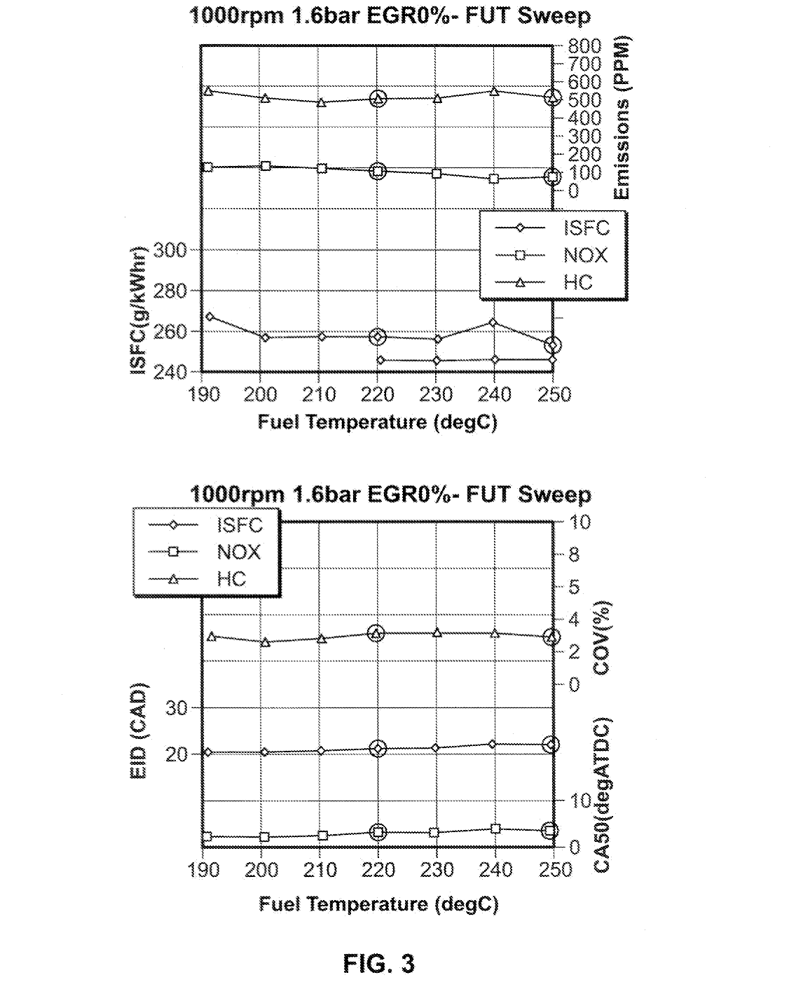

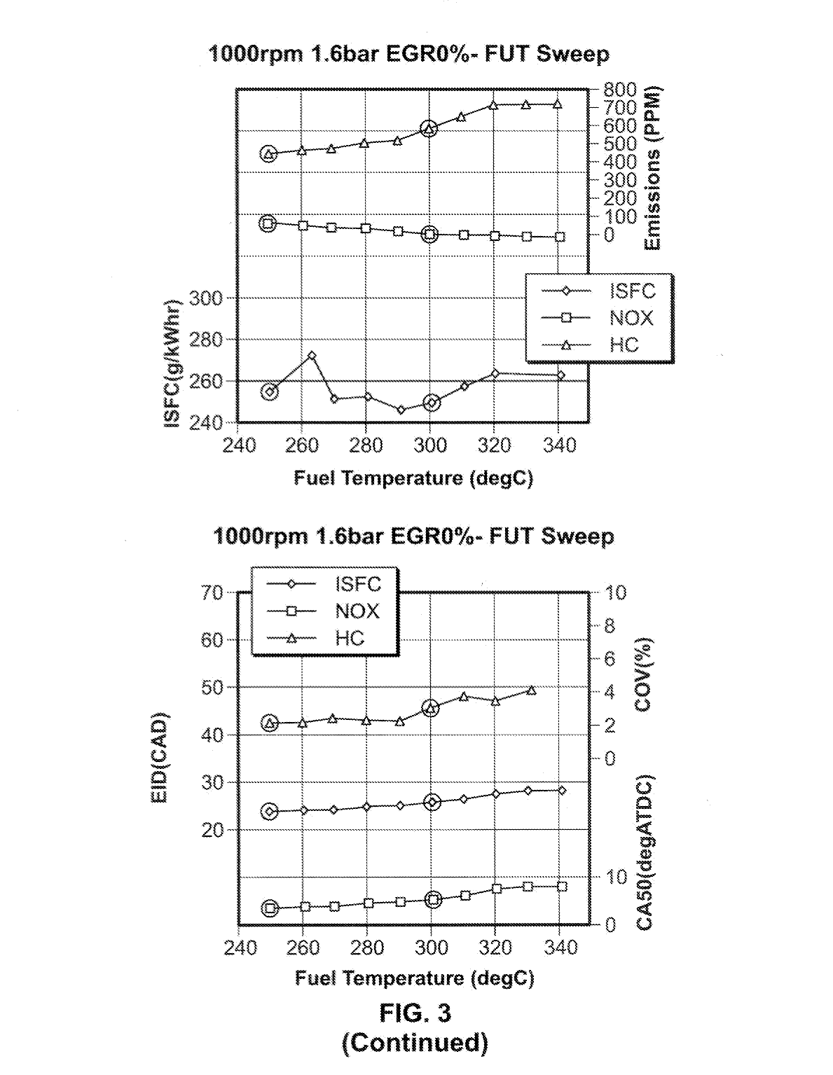

At 1000 rpm and 1.6 bar IMEP using EGRO % and CR17.5:1 and fuel pressure of 205 bar, the fuel temperature was varied from 190° C. to 250° C. and from 250° C. up to 340° C., as shown in FIG. 3, which includes four graphs illustrating fuel temperature impact on engine ignition delay for 1000 rpm.

It can be seen that the fuel temperature had a strong impact of engine ignition delay (EID), which is defined CA50-SOI, where CA50 is the crank angle where 50% of mass fraction of fuel is burned, and SOI is the start of injection. EID is an indicator of the level of fuel premix combustion; a longer EID is indicative of increased premix (i.e., more dilute mixture). An increase in fuel temperature from 250° C. to 300° C. extends EID from 22 to 26 CAD. This resulted in a decrease of NOx from 78 ppm to 58 ppm, with an increase in HC from 450 ppm to 600 ppm with increased trend in fuel consumption. Fuel temperature was shown to increase premix level and extend EID at low loads.

Fuel Temperature Impact at Medium Load

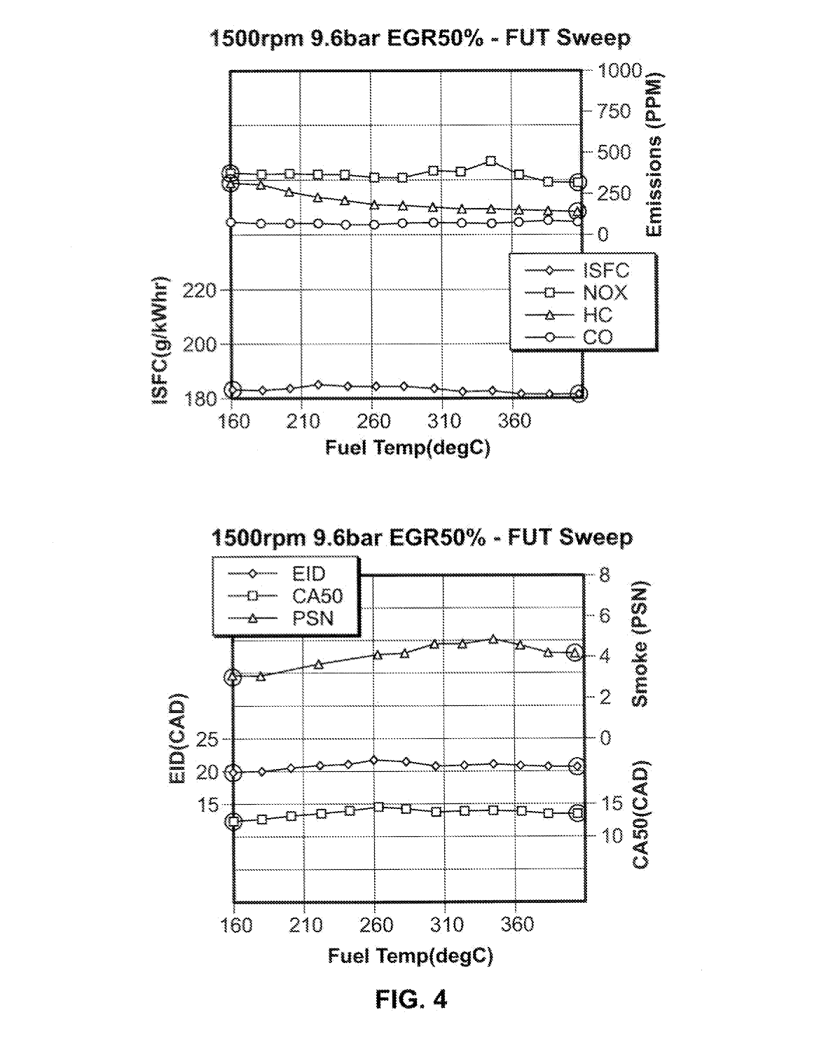

Engine testing at medium load point 1500 rpm 9.6 bar IMEP has also been conducted with EGR50% and boost pressure at 290 kPa, absolute. FIG. 4 includes two graphs illustrating fuel temperature impact on engine ignition delay for 1500 rpm.

As shown in FIG. 4, the fuel temperature was varied from 160° C. to 400° C. The engine ignition delay varies across this range from 19 to 23 CAD, with the maximum EID occurring at 260° C. AT 160° C. fuel temperature decreased EID, and lowered smoke from 4.7 to 3.0 FSN as compared with 340° C. The EGR was adjusted to maintain constant NOx level, but the HC increased from 180 ppm to 300 ppm, with an improvement in combustion stability from COVimep 4.9% to 3.8% and maintaining of fuel economy. When fuel temperature was increased from 340° C. to 400° C. to supercritical levels, the smoke emissions reduced from 4.9 to 4.0 FSN, with improvement in HC from 180 ppm to 150 ppm and a reduction in fuel consumption from 184 g/k Whr to 180 g/k Whr. The decrease in emissions and improvement in fuel consumptions along with shortening of engine ignition delay indicates that a high degree in premix has occurred when temperature was increased. Accordingly, fuel temperature can be used as a means to control premix versus stratification to time tune the performance, fuel consumption and emissions for a medium load point.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A fuel injection system for a variable temperature and variable pressure direct injection engine, comprising:
a high-pressure fuel pump capable of providing fuel at a pressure between 100 bar and 800 bar;
a fuel heater for heating the fuel from 50° C. to 500° C.; and
a common fuel rail operatively connected to at least one direct injector for injecting heated fuel into a cylinder of the engine.

2. The system of claim 1, wherein fuel heating is achieved in an exhaust gas recirculating system.

3. The system of claim 2, wherein a ratio of air to an amount of fuel is maintained in a range from 12.0:1 to 150.0:1 by volume.

4. The system of claim 1, wherein the fuel heater derives its heating energy from an electric source.

5. The system of claim 1, wherein the high-pressure exhaust gas recirculation system comprises a single-loop exhaust gas recirculation system.

6. The system of claim 1, wherein the low-pressure and high-pressure exhaust gas recirculation system comprises a double-loop exhaust gas recirculation system.

7. The system of claim 1, wherein the direct injector is capable of injecting fuel at an elevated temperature of up to 500° C. and an elevated pressure of up to 800 bar.

8. The system of claim 1, wherein the direct injector enables single or multiple injection events directly into the cylinder from intake valve opening to exhaust valve opening, at various in-cylinder pressure and temperature levels.

9. The system of claim 1, wherein the direct injector includes a secondary heating element that provides fine tune control of temperature.

10. The system of claim 9, wherein the secondary heating element may or may not be used in conjunction with the fuel pre-heater.

11. The system of claim 1, wherein the injector individually regulates the temperature, pressure and fuel flow rate provided to the cylinder.

12. The system of claim 1, wherein the heated and pressurized fuel is in a supercritical phase.

13. The system of claim 1, wherein the heated and pressurized fuel is in a gaseous phase.

14. The system of claim 1, wherein the heated and pressurized fuel is in a liquid phase.

15. The system of claim 1, wherein a multiple elevated temperature injection strategy is employed to develop a stratified fuel charge, whereby a reduced amount of fuel is injected in at least two stages.

16. A method for fuel injection for a variable temperature and pressure direct injection engine, comprising:
introducing air, including exhaust gas present at levels greater than 20% by total air mass:
introducing the air and exhaust gas into a combustion chamber of the engine, the combustion chamber defined by a volume between a piston and a cylinder head;
injecting the fuel at a variable temperature and pressure; and
igniting the fuel.

17. The method of claim 16, wherein a ratio of air to an amount of fuel is maintained in a range from 12.0:1 to 150.0:1 by volume.

18. The method of claim 16, fuel is injected at an elevated temperature of up to 500° C. and an elevated pressure of up to 800 bar.

19. The method of claim 16, wherein injecting the fuel involves multiple injection events for injecting fuel directly into the combustion chamber from intake valve opening to exhaust valve opening, at various in-cylinder pressure and temperature levels.

20. The method of claim 16, further comprising heating the fuel using a combination of exhaust gas and a secondary heating element.

21. The method of claim 16, wherein injecting the fuel at an elevated temperature and pressure comprises injecting the fuel in a supercritical phase.

22. The method of claim 16, wherein a multiple elevated temperature injection strategy is employed to develop a stratified fuel charge, whereby a reduced amount of fuel is injected in at least two stages.
